(19) United States
(12) Patent Application Publication
(10) Pub. No.: US 2026/0105418 A1
(43) Pub. Date: Apr. 16, 2026

(54) AI-DRIVEN ACTIVITY AND CALENDAR GENERATION

(71) Applicant: FanThreeSixty, LLC, Leawood, KS (US)

(72) Inventors: Jerad Frey, Kansas City, MO (US); Caleb Overman, Kansas City, MO (US); Matt Stramel, Parkville, MO (US); Troy Tetzlaff, Raymore, MO (US); Jay Vaglio, Mission, KS (US)

(21) Appl. No.: 18/917,503

(22) Filed: Oct. 16, 2024

(51) Int. Cl. G06Q 10/1093; G06F 16/951

(52) U.S. Cl. CPC G06Q 10/1093; G06F 16/951

(57) ABSTRACT

Platforms, methods, and computer-readable media for generating an activity associated with an event. A platform may include an event data set corresponding to the event, the event data set comprising a plurality of data types. The platform may include an activity generator for generating the event based on the event data set, the activity generator comprising a machine learning model trained on a historical data set, wherein the activity generator is operable to analyze the event data set to determine one or more activities achieving a predetermined metric, wherein the one or more activities comprise the activity. The machine learning model may be a generative artificial intelligence model. The platform may include an orchestrator for receiving the activity from the activity generator, wherein the orchestrator provides the activity to a client.

### BACKGROUND

### 1. Field

Embodiments of the present disclosure relate to schedule and activity management systems. More specifically, embodiments of the present disclosure relate to artificial intelligence-based event and schedule generation systems using data relationships.

### 2. Related Art

For much of recorded human history, events—whether they be games, performances, ceremonies, parties, or any other types of events—have permeated societies worldwide, often serving to unite neighbors and spread the arts. Many events over the course of human history have had far-reaching societal, cultural, economic, and environmental impacts, often influencing people many years after the event occurred. For example, it is common for a particular play in a particular football game to be talked about 30 years after the fourth quarter ended and the players left the field.

Tracking the impact that any given event makes has the potential to provide all parties involved with valuable information to inform future events. For example, tracking the impact of an event may inform teams, institutions, universities, sponsors, marketing teams, and other entities involved in an event on what made the event impactful versus what detracted from the event's impact. Thus, entities may use tracked impact data to shape their approaches for future events, such as their marketing strategies, ticket-selling strategies, content strategies, campaigns, reporting, and sponsorship deals.

Tracking the impacts of events, however, can be challenging and complex for a number of reasons. For example, it may be challenging to capture both long-term and indirect references made to an original event, thus making it hard to determine the full scope of the impact of the event. For another example, significant inconsistencies may exist in the way the data corresponding to events is recorded, making it difficult to draw relational connections between differing data points and design systems able to analyze differing data point formats. For a final example, systems analyzing and relating impact data may be required to account for a wide range of data formats across a wide range of entities, making designing said systems challenging, complex, and time consuming. As such, systems and methods for tracking the full impact of events by comprehensively standardizing and relating data are desired.

### SUMMARY

In some aspects, the techniques described herein relate to a platform for generating an activity associated with an event, the platform including: an event data set corresponding to the event, the event data set including a plurality of data types; an activity generator for generating the event based on the event data set, the activity generator including a machine learning model trained on a historical data set, wherein the activity generator is operable to analyze the event data set to determine one or more activities achieving a predetermined metric, wherein the one or more activities include the activity; and an orchestrator for receiving the activity from the activity generator, wherein the orchestrator provides the activity to a client.

In some aspects, the techniques described herein relate to a platform, further including: a universal event ID generator for generating a first universal event ID associated with the event data set and a second universal event ID, wherein the first universal event ID is different than the second universal event ID.

In some aspects, the techniques described herein relate to a platform, wherein the universal event ID generator includes: a universal individual ID generator for generating an individual ID associated with an individual ticket for the event.

In some aspects, the techniques described herein relate to a platform, wherein the universal individual ID generator regenerates the individual ID at a predetermined time.

In some aspects, the techniques described herein relate to a platform, further including: a processing engine for cleansing the event data set such that the event data set is in a standardized format, the processing engine outputting processed data, wherein the processed data is utilized by the activity generator for generating the activity.

In some aspects, the techniques described herein relate to a platform, wherein the plurality of data types include at least one of platform data, communications data, ticket data, purchase data, third-party data, external factor data, or content data.

In some aspects, the techniques described herein relate to a platform, further including: an insights and analytics engine for calculating one or more insights associated with the event data set; and an automatic event detector, wherein the automatic event detector is a web scraper for locating information indicative of at least one of an additional event or external factor.

In some aspects, the techniques described herein relate to a method for generating an activity associated with an event, the method including: receiving an event data set associated with the event, wherein the event data set includes a plurality of data types; analyzing, via an activity generator, the event data set to determine one or more activities achieving a predetermined metric, wherein the one or more activities include the activity; generating the activity based on the event data set, the activity generator including a machine learning model trained on a historical data set; and outputting the activity to an orchestrator such that the orchestrator can provide the activity to a client.

In some aspects, the techniques described herein relate to a method, wherein receiving the event data set associated with the event includes: scraping, using an automatic event detector, one or more web pages to gather the event data set associated with the event.

In some aspects, the techniques described herein relate to a method, wherein the machine learning model is a generative machine learning model.

In some aspects, the techniques described herein relate to a method, wherein the method further includes: generating a universal event ID associated with the event data set and the event, wherein the activity generator distinguishes an input based on the universal event ID.

In some aspects, the techniques described herein relate to a method, further including: receiving the historical data set including at least one of a past event, a past content, or a past material; and training the machine learning model to generate the one or more activities using the historical data set.

In some aspects, the techniques described herein relate to a method, wherein the predetermined metric is a predetermined threshold, where the event exceeds the predetermined threshold.

In some aspects, the techniques described herein relate to a method, the method further including: generating, via the activity generator, a programming calendar including: a plurality of existing events including the event; and the activity, wherein the activity includes information indicative of a time of occurrence relative to the event.

In some aspects, the techniques described herein relate to one or more non-transitory computer-readable media including computer-executable instructions that, when executed by at least one processor, perform a method of generating an activity associated with an event, the method including: receiving an event data set associated with the event, wherein the event data set includes a plurality of data types; analyzing, via an activity generator, the event data set to determine one or more activities achieving a predetermined metric, wherein the one or more activities include the activity; generating the activity based on the event data set, the activity generator including a machine learning model trained on a historical data set; and outputting the activity to an orchestrator such that the orchestrator can automatically update a programming calendar to include the activity.

In some aspects, the techniques described herein relate to one or more non-transitory computer-readable media, wherein the event data set includes a plurality of data formats such that at least one of a first syntax or a first semantic of a first data subset in the event data set differs from at least one of a second syntax or a second semantic of a second data subset in the event data set.

In some aspects, the techniques described herein relate to one or more non-transitory computer-readable media, wherein the method further includes: processing the event data set such that the event data set is in a standardized format and a first format of the first data subset is identical to a second format of the second data subset.

In some aspects, the techniques described herein relate to one or more non-transitory computer-readable media, wherein the method further includes: generating a second event based on a second event data set, where the event is a first event and the event data set is a first event data set.

In some aspects, the techniques described herein relate to one or more non-transitory computer-readable media, wherein the method further includes: updating the programming calendar to include the second event; and causing display of, via a graphical user interface, the programming calendar to a client.

In some aspects, the techniques described herein relate to one or more non-transitory computer-readable media, wherein the method further includes: determining, using the machine learning model, one or more insights relating to the event data set; and formatting the one or more insights into at least one of a graph or a chart.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 depicts an exemplary hardware system in accordance with embodiments of the invention;

FIG. 2 depicts an exemplary event relationship diagram in accordance with embodiments of the invention;

FIG. 3 depicts an exemplary data analytics and orchestration platform in accordance with embodiments of the invention;

FIG. 4 depicts an exemplary system for training a machine learning model in accordance with embodiments of the invention;

FIG. 5A depicts an exemplary universal event code flow for an existing event in accordance with embodiments of the invention;

FIG. 5B depicts an exemplary universal event code flow for a detected event in accordance with embodiments of the invention;

FIG. 6 depicts an exemplary flowchart for illustrating the operation of a method in accordance with embodiments of the invention;

FIG. 7 depicts an exemplary flowchart for illustrating the operation of a method in accordance with embodiments of the invention;

FIG. 8A depicts an exemplary AI-based programming calendar in accordance with embodiments of the invention; and

FIG. 8B depicts an exemplary AI-based season calendar in accordance with embodiments of the invention.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

The invention generally relates to a platform for generating an activity associated with an event. An activity may be any event, material, or metadata associated with the event. Event information may be received from a client and inputted into a universal event ID generator. The universal event ID generator may generate an event ID associated with the event information. The event ID, the event information, and historical data may be coalesced into an event data set. The event data set may include a plurality of data types, including content data, ticket data, communications data, and third-party data.

The event data set may be processed and then utilized by an activity generator for generating an activity. The activity generator may analyze the event data and generate an activity based on the event data. The activity generator may also determine if the activity achieves one or more predetermined metrics, where the one or more predetermined metrics may be defined by the client. The activity generator may be a machine learning model, such as a generative artificial intelligence model. The generated activity may be deployed to an audience or added to a programming calendar, where the programming calendar captures the temporal relationship between one or more events associated with a season.

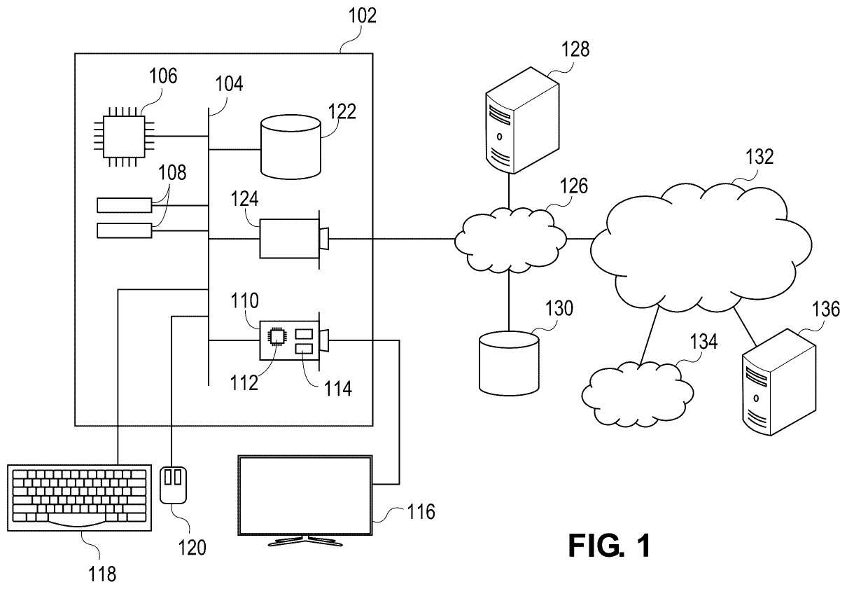

FIG. 1 illustrates an exemplary hardware platform relating to some embodiments of the present disclosure. Computer 102 can be a desktop computer, a laptop computer, a server computer, a mobile device such as a smartphone or tablet, or any other form factor of general-or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Such non-transitory computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth®, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

### Relational Event Data

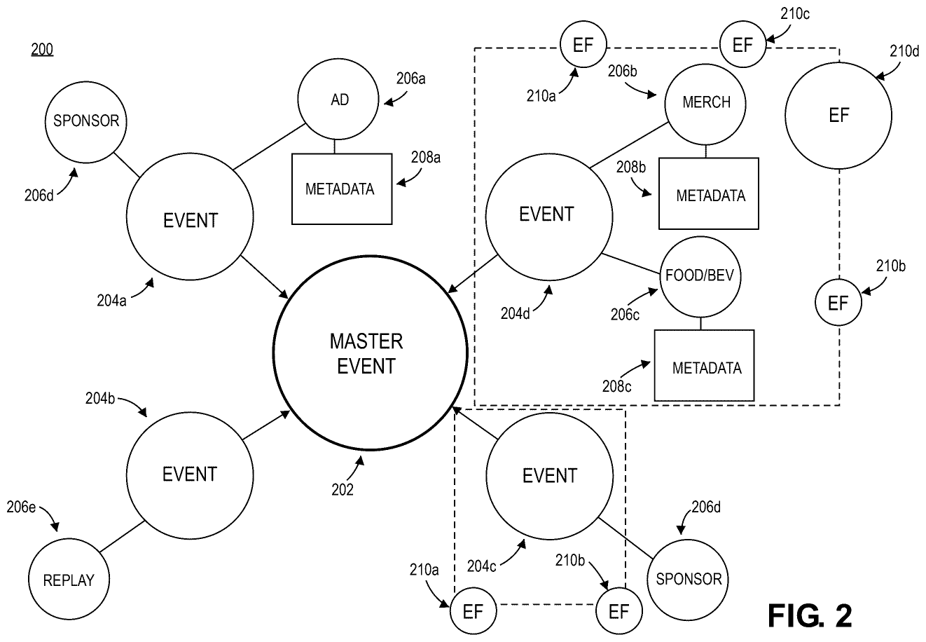

For illustrative purposes, FIG. 2 depicts an exemplary event relationship diagram in accordance with embodiments of the invention and generally referred to by reference numeral 200. Generally, event relationship 200 represents the interconnectivity of events, external factors impacting the events, materials associated with events, and the metadata associated with materials. Thus, all the data from interconnected events, materials, and metadata may define the entire scope of the impact of an event.

Broadly, an event may be any performance, game, sports game, party, program, show, ritual, ceremony, or similar item. For example, in the scope of a football team, an event may be a football game, including, but not limited to, a home game, away game, playoff game, championship game, or preseason game. Additionally, for a football team, an event may be a watch party, a pregame program, an alumni fundraising event, an award ceremony, or any similar activity. As illustrated, the term event may be defined broadly to encompass all activities associated with an entity.

In some embodiments, master event 202 is an overarching event from which one or more additional events originate. For example, master event 202 may be a playoff game, where multiple events surround the playoff game, such as watch parties, alumni events, in-venue contests, and tailgating parties. Master event 202 may be connected to events occurring before, during, or after master event 202. Thus, all connected events are analyzed when determining the entire scope of impact of master event 202, such as the entire economic scope of master event 202.

To illustrate, event 204a, event 204b, event 204c, and event 204d may be events originating from master event 202. Event 204a and event 204d may be events occurring before master event 202, such as a pregame show and an in-venue fan event, respectively. Event 204b may be an event occurring after master event 202, such as an alumni award ceremony occurring three months after master event 202. Event 204c may be an event occurring during master event 202, such as a watch party for master event 202. Despite event 204a, event 204b, event 204c, and event 204d being different types of events that occur at different times in relation to master event 202, event 204a, event 204b, event 204c, and event 204d may be relationally connected to master event 202 such that event 204a, event 204b, event 204c, and event 204d are included in the calculus of the impact of master event 202.

In some embodiments, external factors impact events. Generally, an external factor is an event, situation, community parameter, etc., affecting at least one aspect of an event. External factors may be indirectly related to an event, meaning that an external factor may be unrelated to the event or the associated master event but yet impact the event and, in turn, the master event. External factors may impact a singular event or a plurality of events. For example, event 204d and event 204c may both be affected by external factor 210a and external factor 210b, where external factor 210a is the weather and external factor 210b is a parade. External factor 210a may be affecting event 204d and event 204c, if, for example, the weather is unideal due to extreme temperatures and/or precipitation. Accordingly, elements such as the event-attendee turnout and the venue of event 204d and event 204c may be affected by external factor 210a. Other examples of external factors may include external factor 210c being a conference held in the same venue as event 204d and external factor 210d being a concert held in the same city as event 204d.

In some embodiments, external factors have varying magnitudes of effects on different events. For example, if event 204c is an outdoor event and event 204d is an indoor event, external factor 210a of rainy weather may impact event 204c more than event 204d, due to event 204c being an outdoor event. In some embodiments, external factors have varying magnitudes of effects on the same event. For example, external factor 210d being a concert in the same city as event 204d may have a greater impact than external factor 210a, external factor 210c, and external factor 210b, due to external factor 210d greatly increasing the price of hotels in the area of event 204d, resulting in a significantly lower percentage of pre-event ticket sales relative to similar events.

In some embodiments, event 204a, event 204b, event 204c, and event 204d may each have any number of associated materials 206. Broadly, materials 204 may include any item provided by an entity associated with the event, including, but not limited to, marketing materials, advertisements, game analysis, images, audio, video, content, interviews, sponsored content, televised programs, media content, surveys, news articles, forms, reminders, notifications, emails, texts, phone calls, merchandise, food and beverage, sponsors, highlight reels, communications, and replays.

While events associated with master event 202 may include the same and/or similar materials 206 as other events associated with master event 202, it is also contemplated that events may include different materials 206 from other events associated with master event 202. For example, event 204a may have an advertisement 206a and sponsor 206d. Similarly, event 204c may also be associated with sponsor 206d. In contrast, event 204b may include replay 206e, while event 204d may include merchandise 206b and food and beverages 206c.

In some embodiments, materials 206 may have associated metadata 208, which may add complexity to determining the entire scope of impact of master event 202. Metadata 208 may encompass the broad range of information associated with any given piece of material. For example, metadata 208b for merchandise 206b may include T-shirt sizes, styles of T-shirts, stock-keeping units (SKUs), and colors; metadata 208a for advertisement 206a may include brand names and GS1 prefixes; and metadata 208c for food and beverages 206c may include food and drink items, prices, inventory amounts, and suppliers.

As illustrated by the discussion of FIG. 2 above, events may be interconnected with other events, external factors, materials, and metadata. The complexity of capturing the scope of data associated with events and master events and drawing relationships between the data associated with events and master events may increase as the number of events, materials, and metadata associated with a given master event increases. Thus, for events, programs, and seasons with a plurality of events, tracking the impact of each event may be a complex and difficult process.

### Event Data Analytics and Orchestration Platform

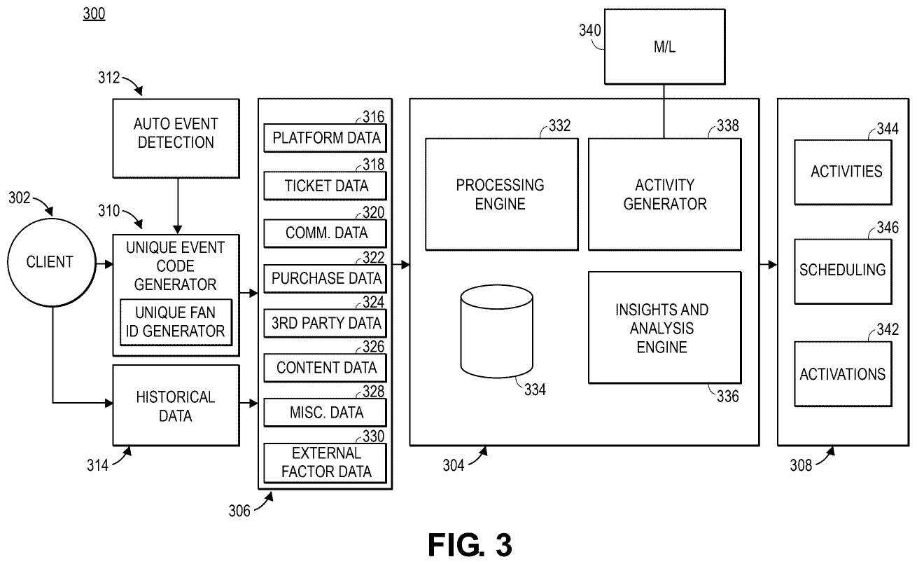

FIG. 3 depicts an exemplary data analytics and orchestration platform in accordance with embodiments of the invention and generally referred to by reference numeral 300. Platform 300 facilitates the creation of a comprehensive ledger of events, materials, and metadata associated with client 302, a master event, a season, and/or a program, thereby forming a relational network such as that described above with regard to FIG. 2. The ledger may then be used to generate insights on the event, season and/or program, generate future activities, and capture impact. At a high level, data platform 304 receives and analyzes event data 306 to formulate insights and generate activities. Accordingly, the insights and activities may then be used by orchestrator 308 for any number of responsive actions.

To begin, client 302 may input event information in any format into universal event ID generator 310. Client 302 may be any entity associated with an event, such as a business, organization, sponsor, sports team, program, or entertainment provider. Client 302 may be an entity putting on the event, hosting the event, or sponsoring the event. Accordingly, client 302 may have information surrounding the event, such as the event type, event name, tickets sold, metadata for the tickets sold, and any other information. For example, client 302 may be a sports team that hosts home games. Thus, for every home game, client 302 may collect a set of information associated with the game or a set of games, including, but not limited to, the number of tickets sold, individuals who purchased tickets, the materials distributed during the event, what seats were purchased, and the companies who sponsored the event. In some embodiments, the event information is in a format specific to client 302. In some embodiments, the event information is in a plurality of formats.

Accordingly, client 302 may provide event information to universal event ID generator 310. Generally, universal event ID generator 310 creates a universal event identifier (e.g., ID) to associate with the event and/or events corresponding to the event information. The event ID generated may be unique such that no other event is described by the generated event ID. Additionally, the event ID may be standardized for platform 300 such that all event IDs generated for universal event ID generator 310 are subject to the same syntax and semantics. Further, the event ID may be standardized to be understood and processable by data platform 304.

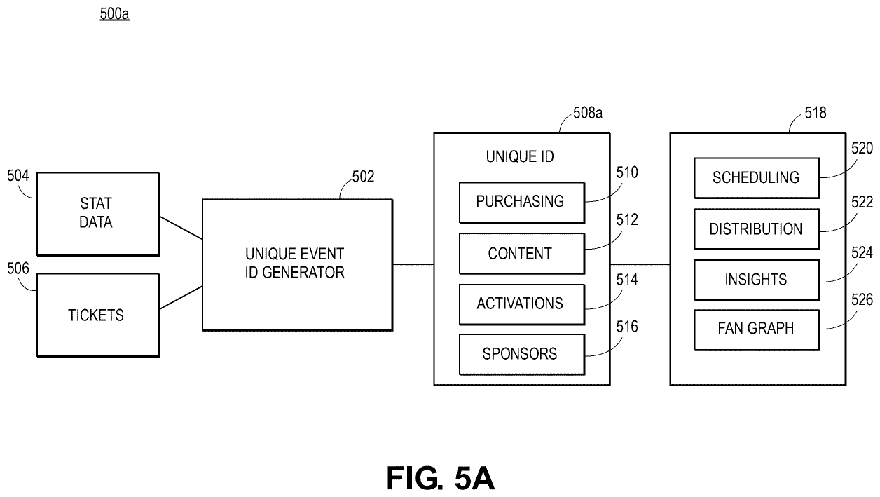

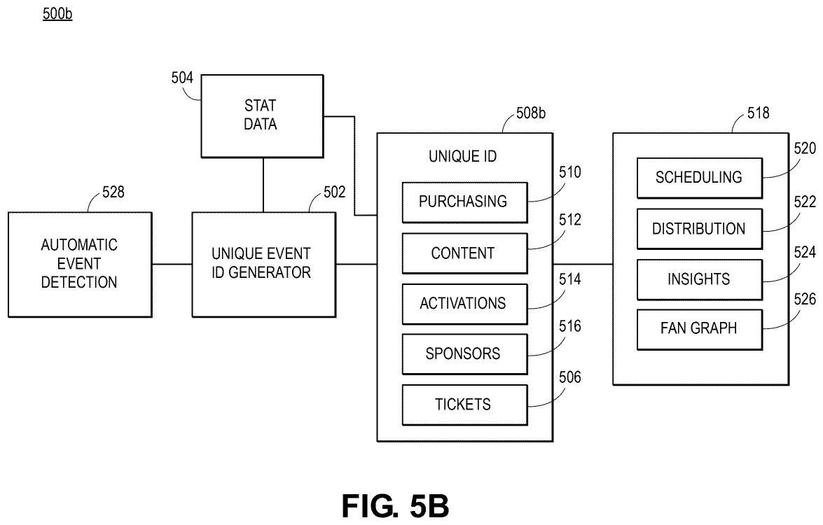

In some embodiments, it may be desirable to associate a set of individuals with an event. For example, it may be desirable to record the individuals who purchased tickets for an event, such as a soccer game. In such embodiments, universal event ID generator 310 includes a universal individual ID generator for generating individual IDs. An individual may be any person or entity associated with an event, such as an attendee, a sports fan, a ticket buyer, a merchandise buyer, and the like. By tracking information regarding the individuals who are associated with an event, client 302 may receive insights into the behaviors, tendencies, and motives of individuals, thus allowing client 302 to cater to certain individuals. The generation of event IDs and individual IDs is described further below with respect to FIGS. 5A-5B.

In some embodiments, in a similar fashion to client 302, automatic event detector 312 may input event information into universal event ID generator 310. Automatic event detector 312 may analyze a variety of sources to discover events (including events unknown to client 302), such as events found on the internet. For example, a watch party for a sporting event hosted by a local business may be related to the sporting event, despite not being hosted by client 302. In such an example, automatic event detector 312 may discover information about the watch party on a social media platform account of the local business and input the event information into universal event ID generator 310 for generating a new event ID associated with the watch party.

In some embodiments, automatic event detector 312 is an automatic web scraping application (e.g., a web scraper). For example, automatic event detector 312 may automatically navigate through the internet and parse information off web pages. In doing so, automatic event detector 312 may locate information about events and/or external events (e.g., external factors), which may then be structured as event information. Accordingly, the event information may then be inputted into universal event ID generator 310 for generating an event ID associated with the discovered event. The event information gathered by automatic event detector 312 may be substantially similar to that provided by client 302. For example, automatic event detector 312 may gather information regarding the name of an event, the time of an event, the type of event, attendees of the event, and the like.

In some embodiments, automatic event detector 312 utilizes one or more machine learning models to determine when information is describing an event and/or relates to another event. Machine learning models utilized by automatic event detector 312 may be any suitable model now known or later developed, including, but not limited to, linear regression, logistic regression, support vector machines, naive bayes, k-nearest neighbors, boosting algorithms, decision trees, random forest, neural networks, classifiers, reinforcement learning, cluster analysis, k-means clustering, large language models, and similar machine learning models. The one or more machine learning models used to detect information indicative of an event and corresponding event information may be trained in a substantially similar manner to machine learning model 406 described below.

In some embodiments, historical data 314 associated with event information (and, consequently, the generated event ID) may be included in event data 306. Historical data 314 may broadly encompass data relating to past events and activities that may be used to inform future events. For example, historical data 314 may include, but is not limited to, data associated with past events, programs, outcomes, successes, failures, promotions, seasons, sponsors, statistics, number of attendees, and other similar information. For example, historical data 314 may include all data associated with a prior football season, such as the number of games, wins and losses of games, the sponsors of games, and the number of attendees of games. Consequently, historical data 314 associated with a prior football season may then be used by platform 300 to inform events, activities, content, scheduling, and activations of the present and/or future season.

As mentioned above, event data 306 may include all information associated with a particular event ID and historical data 314. Event data 306 may be broken into a variety of data categories, including platform data 316, ticket data 318, communications data 320, purchase data 322, third-party data 324, content data 326, and miscellaneous data 328. Platform data 316 may include data directly imported into data platform 304. For example, platform data 316 may include data imported in spreadsheet format into data platform 304. Platform data 316 may include data from one or more applications associated with data platform 304, including, but not limited to, mobile application data. Ticket data 318 may include data involved in the ticketing process, including number of tickets purchased, purchasers of tickets, ticket numbers, the origins of ticket purchases, and any other information associated with tickets.

Communications data 320 may encompass data related to communications, such as emails, text messages, phone calls, promotional materials, and other communication information. For example, communications data 320 may include information on surveys sent out to attendees of an event, including the survey responses. Purchase data 322 may include data relating to sales and merchandising. For example, purchase data 322 may include information regarding T-shirt sales and food and beverage sales. Third-party data 324 may include information gathered by and/or received from third-party sources. Examples of third-party data 324 include weather data, census data, and credit bureau data.

Content data 326 may encompass any data related to content distributed in relation to an event. Content may include videos, audio, pictures, articles, and any other media forms. For example, content data 326 may include highlight reels, replay videos, pregame shows, and advertisements. Content data 326 may include sponsored content, such as content funded by a sponsor. Miscellaneous data 328 may include all other information associated with an event, such as Wi-Fi network data from a venue in which an event took place. Lastly, external factor data 330 may include information related to external factors (as described above with regard to FIG. 2). For example, processing engine 332 may include forecast information and external event information, such as unrelated events occurring at a time/location in the same area/vicinity/city of the event.

The variety of data types in event data 306 may provide a fuller picture of the data, circumstances, and outcome surrounding an event, rather than relying on a singular category for event information. For example, if ticket data 318 indicates that less than half of all tickets purchased were redeemed at the event, client 302 may conclude that a marketing failure may have occurred. Accordingly, if third-party data 324 and external factor data 330 shows that a severe thunderstorm (an external factor) was occurring during the event, client 302 may determine that the low-ticket redemption rate was due to the weather and not a marketing failure.

Upon receiving event data 306 and one or more event IDs from universal event ID generator 310, event data 306 may be ingested into data platform 304. As described above, data platform 304 processes event data 306, provides insights and analysis on the process data, generates activities based on the process data, and provides one or more outputs to orchestrator 308. Accordingly, upon receiving event data 306, processing engine 332 may process event data 306 to obtain processed data.

In some embodiments, processing engine 332 transforms and structures event data 306. For example, processing engine 332 may structure event data 306 in a unified data model, such that data in various forms is coalesced in a uniform structure. By standardizing the structuring of event data 306, differences in the form of data included in event data 306 (for example, differences in the way ticket data 318 and third-party data 324 are stored and structured) may be eliminated to ease in the analysis of event data 306. Additionally, by structuring event data 306 in a singular structure, event data 306 may be more efficiently accessed by having a single point of access.

In some embodiments, processing engine 332 cleanses and validates event data 306. For example, processing engine 332 may cleanse event data 306 by removing incorrect, inaccurate, corrupted, incorrectly formatted, duplicate, mislabeled, or incomplete data from event data 306. For example, if ticket data 318 and purchase data 322 both contain information on revenue generated from ticket sales, processing engine 332 may remove one such data point to prevent duplicates. Additionally, processing engine 332 may validate event data 306 by checking the accuracy, quality, and security of event data 306. Any type of data validation may occur, including syntax validation, semantic validation, business rule validation, and comparison validation. Cleansing and validating event data 306 may ensure quality data that can be analyzed without introducing inaccuracies into the analysis due to inaccuracies in event data 306.

Processing engine 332 may output processed data that is then stored in data store 334. Data store 334 may be any data store type of data store now known or later developed, including, but not limited to, a server, a data warehouse, a relational database, an object-oriented database, a NoSQL database, a cloud database, a hierarchical database, a distributed database, a network database, or a centralized database. Additionally, data store 334 may be a singular data store or a plurality of data stores.

In some embodiments, the processed data may be received by insights and analysis engine 336. Generally, insights and analysis engine 336 analyzes the processed data and performs a number of functions, including drawing conclusions, assessing outcomes, calculating statistics, determining audiences, determining relationships between data points, categorizing individuals, predicting outcomes, and providing insights and analysis to client 302.

For example, insights and analysis engine 336 may output information on the behaviors and tendencies of a plurality of individuals and coalesce those individuals into audience groups. An example of an audience group includes an audience who tends to buy T-shirts at events. In some embodiments, insights and analysis engine 336 may output data to be rendered in graphical presentations of the processed data, such as graphs, charts, written text, and similar structures. For example, insights and analysis engine 336 may output data that is then renderable on a graphical user interface such that client 302 may view the processed data and/or the data insights. For another examples, insights and analysis engine 336 may output data viewable on a web browser, application, or any other program. Insights and analysis engine 336 may utilize any system or process for drawing conclusions, assessing outcomes, calculating statistics, determining audiences, determining relationships between data points, categorizing individuals, predicting outcomes, and providing insights. For example, insights and analysis engine 336 may utilize machine learning to generate one or more audience groups and identify individuals belonging to the group.

Upon processing, the processed data and/or the data insights from insights and analysis engine 336 may be received and used by activity generator 338. Broadly, activity generator 338 may receive the processed data and/the data insights as an input and generate one or more future activity items based on the processed data and/or the data insights. An activity may be any event, season, campaign, program, piece of content, material, material metadata, or set of tasks. For example, activity generator 338 may receive processed data including data on the current KANSAS CITY CHIEFS season and data from previous KANSAS CITY CHIEFS seasons, and output one or more future activity items for the present CHIEFS season or a future CHIEFS season, such as a watch party, an advertisement with a particular sponsor, a texting initiative for a predetermined audience, or a merchandising campaign.

Activities may be generated based on one or more pre-determined metrics. In some embodiments, client 302 may define one or more metrics client 302 is hoping to achieve through an activity. Example metrics include maximizing profit, maximizing viewership, maximizing viewership for a specified audience group, maximizing redeemed tickets, reaching a predetermined ticket sold threshold, and any other metric. Accordingly, activity generator 338 may generate content to reach a certain metric and or maximize the likelihood that the metric will be reached. In some embodiments, activity generator 338 may generate multiple activities that all achieve a particular metric. In such embodiments, activity generator 338 may select an activity to output based on a secondary metric, activity generator 338 may randomly pick an activity to output, or activity generator 338 may all activities achieving the particular output.

In some embodiments, activity generator 338 analyzes the processed data to determine relationships and correlations between events, materials, and outcomes. As such, activity generator 338 may draw conclusions on factors that lead to successful outcomes and factors that result in failures. Broadly, successful outcomes may be defined as any outcome desired by client 302, such as a predetermined metric being achieved. For example, a successful outcome may be a ticket redemption rate above a predetermined threshold. For another example, a successful outcome may be a revenue rate above a predetermined threshold. For another example, a successful outcome may be the engagement of a particular audience group for a particular event reaching a predetermined threshold. Conversely, a failure may correspond to an undesirable result defined by client 302, such as an unreached metric. For example, a failure may be an audience engagement percentage below a predetermined threshold. For another example, a failure may be a lack of viewership on a program.

In some embodiments, activity generator 338 analyzes the events, content, materials, and activations that resulted in particular outcomes. For example, activity generator 338 may analyze which promotions lead to greater engagement after a team had a three-game losing streak. For another example, activity generator 338 may analyze which advertisements from previous seasons resulted in the greatest number of season ticket purchases before the season started. As such, activity generator 338 may correlate certain actions to certain outcomes.

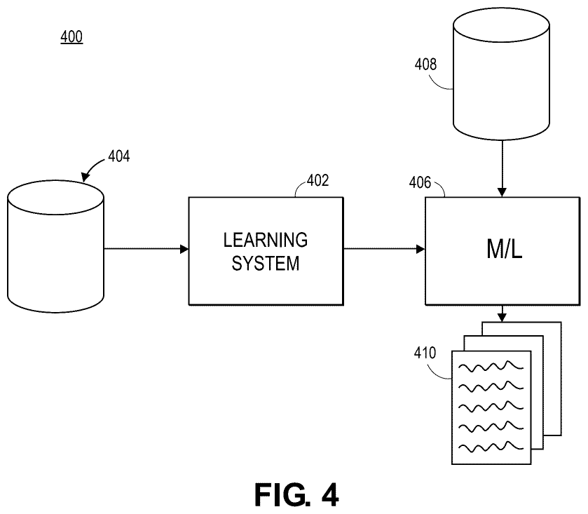

In some embodiments, activity generator 338 uses machine learning model 340 to analyze the process data and generate activities. Machine learning model 340 may be a singular machine learning model or a plurality of machine learning models. Machine learning model 340 may be trained to receive the processed data, analyze the processed data to generate one or more activities that achieve a metric, and output the generated activities. Machine learning model 340 may be retrained based on the generated activities, present event data, and future event data. Machine learning model 340 is discussed further below with respect to FIG. 4.

Finally, data platform 304 provides one or more outputs to orchestrator 308. At a high level, orchestrator 308 receives outputs regarding the processed data, including insights, analysis, and generated activities, and performs one or more actions based on the outputs. In some embodiments, orchestrator 308 causes activations 342 to occur. An activation may be a piece of material being distributed or a facilitated experience being hosted. Activations may serve to achieve one or more metrics, as discussed above with regard to activity generator 338. For example, an activation may include a survey to customers, a text message, a mass e-mail, a marketing campaign, a mobile notification, a fan experience such as a sweepstake, and other materials. In some embodiments, activations 342 includes activities 344 outputted by activity generator 338.

In some embodiments, orchestrator 308 receives activities 344 generated by activity generator 338. For example, activity generator 338 may generate and output a particular event idea, material, advertisement, or other piece of content. Accordingly, orchestrator 308 may provide activities 344 to client 302 such that client 302 can provide activities 344 to an audience. In some embodiments, orchestrator 308 automatically provides activities 344 to an audience via activations 342.

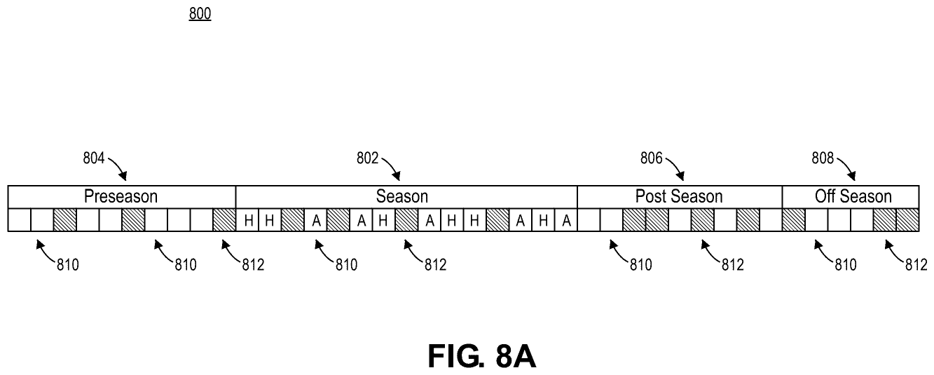

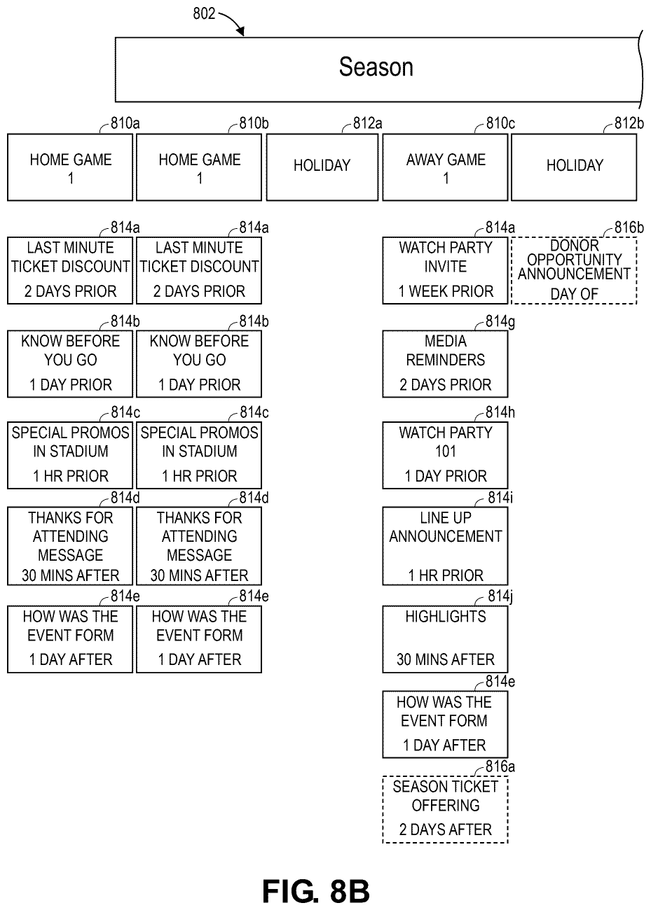

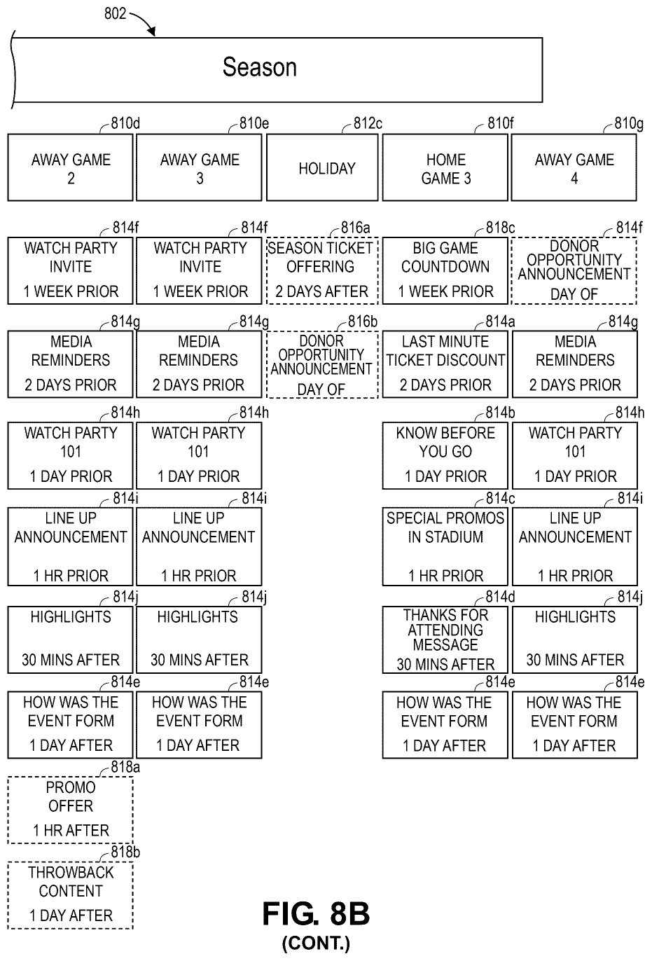

In some embodiments, as discussed further below with regard to FIGS. 8A-8B , orchestrator 308 may deploy one or more schedules via scheduling module 346 based on activities outputted from activity generator 338. Broadly, activity generator 338 may output activities 344 that activity generator 338 determines will reach a particular metric, such as a revenue metric. Accordingly, the content outputted by activity generator 338 may be added to a schedule generated by scheduling module 346 for client 302 such that client 302 may receive the newly generated content for deployment to an audience. In some embodiments, a schedule generated by scheduling module 346 is presented to the client on a graphical user interface in the form of a calendar, as is depicted in and discussed more below with regard to FIGS. 8A-8B.

In some embodiments, activities 344 outputted by activity generator 338 may be automatically added to a schedule generated by scheduling module. For example, if activity generator 338 determines that the current season for a particular sport for a team is losing an audience group from its fan base, activity generator 338 may output one or more promotions to increase engagement of the audience group, as specified in a predetermined metric. As such, the promotions may automatically be added to a schedule generated by scheduling module 346 such that the promotions automatically activate at the specified time. In some embodiments, while added to a schedule generated by scheduling module 346, activities 344 may require input from client 302 before activating and being presented to an audience.

As discussed above, activity generator 338 may rely on one or more machine learning models, such as machine learning model 340, to generate and output activities. FIG. 4 depicts an exemplary system for training a machine learning model in accordance with embodiments of the invention and generally referred to by reference numeral 400. Training system 400 may serve to train machine learning model 406, substantially related to machine learning model 340 depicted in FIG. 3.

Training system 400 includes learning system 402 for training machine learning model 406. In some embodiments, learning system 402 trains machine learning model 406 to analyze input 408 and determine activities that will meet a predetermined criteria. For example, machine learning model 406 may be trained by learning system 402 to analyze input 408 to determine if the activity specified in input 408 may result in a selected profit margin, or if additionally generated activities may achieve the selected profit margin.

In some embodiments, after analyzing input 408 relative to one or more predetermined metrics, machine learning model 406 may be trained by learning system 402 to generate one or more activities to achieve one or more predetermined metrics. For example, if the predetermined metric is a particular profit margin, and machine learning model 406 determines via input 408 that the profit margin would be reached and/or exceeded via an advertising campaign, machine learning model 406 may generate one or more activities directed to the advertising campaign.

In some embodiments, learning system 402 trains machine learning model 406 using training data set 404. At a high level, training data set 404 may be associated with a particular organization, client, business, sport, or activity relating to input 408 and/or activities 410. For example, if machine learning model 406 is being used to output content relating to a football season, training data set 404 may relate to football, football seasons, materials distributed to audiences of football, past outcomes of football seasons, historical marketing campaigns, historical marketing campaign outcomes, historical financial data, historical audience data, and any other information related to the context.

As mentioned, training data set 404 may include historical data. For example, training data set 404 may include historical data outlining activities and their overall impact on particular metrics. For example, training data set 404 may include a full ledger of the previous season of performances for an opera house and the events, materials, and merchandise provided for the season. Additionally, training data set 404 may include outcomes of the full ledger of events for the previous season, such as financial data from each event and an analysis of the engagement of a particular audience group.

In some embodiments, training data set 404 may include current data relating to an event, season, program, material, and the like. For example, training data set 404 may include an account of all the upcoming events for a basketball season. As such, machine learning model 406 may analyze the upcoming events to determine activities to generate for said events or additional events. For another example, training data set 404 may include information indicative of a winning streak or losing streak for a sports team. Accordingly, trained machine learning model 406 may use the indication of a winning streak or losing streak to generate content to increase user engagement and/or continue to build hype around the winning streak.

Learning system 402 may train machine learning model 406 to utilize any type of machine learning models now known are later developed, including, but not limited to, generative AI models, generative adversarial networks, variational autoencoders, transformers, stable diffusion models, hybrid models, flow models, recurrent neural networks, neural radiance fields, supervised learning models, unsupervised learning models, semi-supervised learning models, reinforcement learning models, linear regression, logistic regression, support vector machines, naive bayes, k-nearest neighbors, boosting algorithms, decision trees, random forest, neural networks, classifiers, reinforcement learning, cluster analysis, k-means clustering, large language models, and similar machine learning models.

After being trained by learning system 402, machine learning model 406 may receive input 408 for analysis. Input 408 broadly refers to any and all data a user may want machine learning model 406 to account for when generating content. For example, in regard to FIG. 3, input 408 may include processed data in data platform 304. Examples of data include a current schedule outlining future events and past events of a season, current outcomes in relation to predetermined metrics, and predetermined metrics of a season. For example, if the processed data of FIG. 3 includes a list of metrics client 302 desires to achieve over the course of a season, machine learning model 406 may receive said list via input 408 and use the metrics when generating one or more activities to ensure the generated activities are tailored to the predetermined metrics.

After analyzing inputs 408 and generating one or more activities (in a substantially similar fashion to activity generator 338 described above), machine learning model 406 may output one or more activities 410. In some embodiments, machine learning model 406 generates and outputs all potential activities that machine learning model 406 determines meet predetermined metrics. For example, if machine learning model 406 determines five different advertising campaigns may result in a predetermined revenue goal occurring, one or more activities 410 may include all five advertising campaigns. In some embodiments, machine learning model 406 may output one activity 410 corresponding to the best activity based on the predetermined metric. A best activity may be an activity that is determined to meet a predetermined metric quicker or is determined to greater exceed a predetermined metric than other activities. For example, a best activity may be an activity that machine learning model 406 determines will generate the most revenue in a particular time frame. For another example, a best activity may be an activity that is determined will meet an engagement threshold of an audience group quicker than all other contemplated activities.

As discussed above with regard to FIG. 3, in some embodiments, one or more activities 410 are added to a schedule, such as one generated by scheduling module 346. As such, a client may activate one or more activities 410, for example by providing certain content to an audience. In some embodiments, one or more activities 410 are automatically deployed to an audience, such as through activations 342 depicted in FIG. 3. For example, if machine learning model 406 outputs a form for an audience to fill out, the form may be automatically sent to an audience without intervention from a client. In some embodiments, one or more activities 410 are presented to a user of machine learning model 406.

### Universal Event Codes

Often, clients have unique ticketing systems for events to trace and track various pieces of information about an event, including the tickets sold. Different clients, however, often have different ticketing systems using different syntax and semantics to capture similar pieces of data. For example, a first client may use tickets with a seven-digit barcode, whereas a second client may use tickets with a nine-digit barcode. As such, a system designed to analyze the impact of an event may benefit from standardization of events received from clients having different semantics and syntax for capturing data relating to events.

Additionally, as discussed above with universal event ID generator 310, universal event IDs may interconnect various activities under a singular umbrella for tracing the impact of a particular event. By tying materials and events relating to a master event under a singular event ID, all such materials and events may be tracked and analyzed to determine the impact of the master events, such as the total amount of revenue generated, the reach of the audience, and the relevance of the master event for years to come. Additionally, an activity generator, such as activity generator 338 depicted in FIG. 3, may distinguish an input based on an event ID. For example, activity generator 338 may determine if an input relates to a particular event or does not relate to a particular event based on the event ID.

FIG. 5A depicts an exemplary universal event code flow for an existing event in accordance with embodiments of the invention and generally referred to by reference numeral 500a. Broadly, system 500a depicts the integration of data and tickets from an event into a universal event ID which may then capture the data associated with the event. The event data and the corresponding event ID may then be used for various applications, such as scheduling, distribution, and insights. In some embodiments, universal event ID generator 502, generally relating to universal event ID generator 310 depicted in FIG. 3, receives statistical data 504 and tickets 506.

In some embodiments, statistical data 504 includes all data relating to a particular event. For example, if the event is a musical performance, statistical data 504 may include information on merchandise purchasing, food/beverage purchasing, percentage of seats sold, percentage of seats filled, date and time of the performance, performers in the performance, media surrounding the event, historical content regarding the performance, and any other information about the performance. In some embodiments, statistical data 504 is correlated to tickets 506 by universal event ID generator 502. Tickets 506 include information surrounding tickets for an event. For example, tickets 506 may include a list of all tickets sold for an event, including barcodes and skews for each ticket. In some embodiments, tickets 506 includes a list of all individuals who purchased tickets for a particular event. For example, tickets 506 may include a list of all individuals and their corresponding ticket numbers.

Universal event ID generator 502 may receive statistical data 504 and tickets 506 and generate a universal event ID for the event relating to statistical data 504 and tickets 506. In some embodiments, universal event ID generator 502 may use machine learning to determine the correlation between statistical data 504 and tickets 506 such that one or more universal event IDs can be generated. For example, if statistical data 504 and tickets 506 relate to two separate events under a master event, universal event ID generator 502 may generate three event IDs; one event ID for one event, a second event ID for a second event, and a third event ID covering the master event. In some embodiments, universal event ID generator 502 analyzes different data types received through statistical data 504 and tickets 506. For example, statistical data 504 may be received in a variety of formats due to the broad range of data that may be received through statistical data 504. As such, universal event ID generator 502 may use machine learning to analyze all data types of statistical data 504 and correlate them. Similarly to training system 400 depicted in FIG. 4, any type of machine learning now known or later developed may be used to train universal event ID generator 502, including, but not limited to, supervised learning models, unsupervised learning models, semi-supervised learning models, reinforcement learning models, linear regression, logistic regression, support vector machines, naive bayes, k-nearest neighbors, boosting algorithms, decision trees, random forest, neural networks, classifiers, reinforcement learning, cluster analysis, k-means clustering, large language models, and similar machine learning models.

Universal event ID generator 502 may be trained using a training data set, such as training data set 404. The training data set used to train universal event ID generator 502 may include historical event IDs and the statistical data and tickets correlated to the historical event IDs. Accordingly, the historical universal event IDs and the statistical data and tickets correlated to the historical event IDs may assist universal event ID generator 502 in determining how data correlates such that it can be categorized as a singular event. Examples of historical event IDs may include event IDs from past football seasons' games and their corresponding statistical data and tickets.

Alongside generating universal IDs, universal event ID generator 502 may generate and output individual IDs relating to individuals attached to tickets 506. For example, if tickets 506 includes a list of all individuals who purchased a ticket and their corresponding ticket numbers, universal event ID generator 502 may generate a universal individual ID for each individual in the ticket list. By doing so, each universal individual ID may be used to provide insights on individual people, which may be used to create audience groups and achieve particular outcomes dependent on individuals. In some embodiments, universal event ID generator 502 may be operable to generate new universal individual IDs after a predetermined amount of time period. For example, universal event ID generator 502 may be operable to regenerate individual IDs every thirty seconds. Regenerating individual IDs may correspond to regenerated ticket numbers for a particular event. Universal event ID generator 502 may output a universal event ID In the form of a numeral value, alphabetical value, or combination of both. In some environments, a universal event ID may be in the form of computer-readable code.

After being outputted, a universal event ID may capture data set 508a, generally corresponding to event data 306 depicted in FIG. 3. For example, a universal ID may capture purchasing 510, content 512, activations 514, and sponsors 516 for a particular event. It is noted herein that purchasing 510, content 512, activations 514, and sponsors 516 are exemplary in nature, and universal ID may capture any type of data relating to the event, such as the types of data discussed with regard to FIG. 3.

By capturing data set 508a under a singular universal event ID, the data associated with the universal event ID may then be analyzed for orchestrations 518, generally relating to the actions performed by orchestrator 308 depicted in FIG. 3. For example, orchestrations 518 may include scheduling 520, distribution 522, insights 524, and graphs 526. Scheduling 520 may include one or more schedules generated based on insights 524. Distribution 522 may include materials and activities distributed to an audience based on insights 524. Graph 526 may include a display of insights 524, such as through graphs and flow charts showing outcomes of activities of the event captured under the universal event ID.

In some embodiments, as discussed above, events may be automatically detected and a universal event ID may be generated after detection. FIG. 5B depicts an exemplary universal event ID flow for a detected event in accordance with embodiments of the invention and generally referred to by reference numeral 500b. In some embodiments, automatic event detector 528, generally corresponding to automatic event detector 312, may scrape the internet for information indicative of events, including events relating to a master event. For example, automatic event detector 528 may scrape the internet for watch parties associated with the Super Bowl. As such, automatic event detector 528 may provide event information to universal event ID generator 502 for creating a universal event ID.

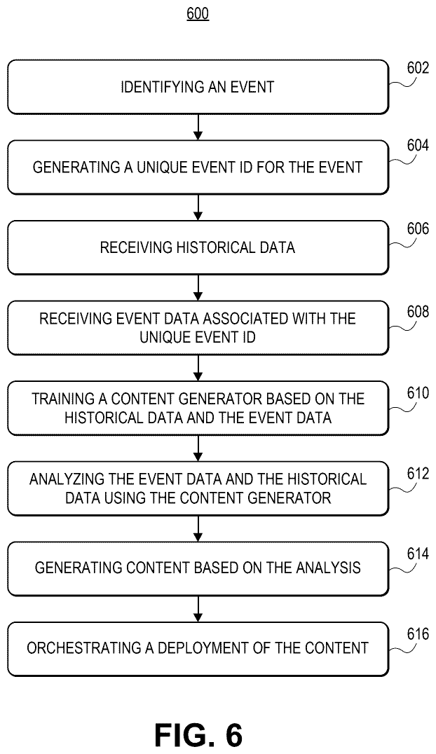

FIG. 6 depicts an exemplary flowchart for illustrating the operation of a method in accordance with embodiments of the invention and generally referred to by reference numeral 600. Method 600 is a method for generating content using machine learning. In step 602, an event is identified. In some embodiments, the event is identified through a client providing information on the event. For example, a sports team may provide information on a game occurring. In some embodiments, an event is identified using an automatic event detector, such as automatic event detector 528. Method 600 may be carried out as a whole or in part by platform 300 depicted in FIG. 3. In step 604, a universal event ID is generated for the event. As discussed above with regard to FIGS. 5A and 5B, the universal event ID may be generated using machine learning. The machine learning model may determine when event information is correlated under a single event and generate an event ID for the event. The universal event ID may capture all data related to the event such that it may be used for analysis later on.

In step 606, historical data is received. The historical data is generally related to historical data 314 and may include information from past events and materials, such as outcomes of marketing campaigns, financial statistics, materials distributed, audiences, and schedules. The historical data may be received by a system utilizing machine learning, such as activity generator 338 depicted in FIG. 3. In step 608, event data associated with the universal event ID may be received. The event data may generally correspond to event data 306 depicted in FIG. 3. For example, the event data may include platform data, ticket data, communications data, purchasing data, third-party data, content data, and miscellaneous data. The event data may be received by a system utilizing machine learning, such as activity generator 338 depicted in FIG. 3.

In step 610, the activity generator is trained based on the historical data. In some embodiments, the activity generator may be generally related to activity generator 338 depicted in FIG. 3 and machine learning model 406 depicted in FIG. 4. For example, the activity generator may be trained to analyze the event data and generate one or more content items based on one or more metrics identified in the event data and/or the historical data. The activity generator may be trained using any method now known or later developed, including generative artificial intelligence techniques. Additionally, the activity generator may be retrained when new historical data and/or event data is received.

In step 612, the event data is analyzed using the activity generator. As described above, the event data may be analyzed to determine which materials and events led to particular outcomes. As such, a correlation can be drawn between certain materials and content and outcomes. As such, in step 614, content may be generated based on the analysis performed in step 612. For example, the activity generator may generate content to achieve a certain metric, such as a particular viewership number. The content generated by the activity generator may include audio content, video content, visual content, advertisement content, marketing content, and any other type of content.

In step 616, the deployment of the content is orchestrated. The content may be provided to a particular audience as specified by the client. In some embodiments, the content may be provided to an audience determined by the activity generator. For example, if the activity generator determines that a particular outcome will be reached if a particular generated piece of content is given to an audience group, the content may be deployed to that audience group. As another example, if the activity generator generates a pregame analysis advertisement that the activity generator determines would be best served to middle-aged men, the deployment of the content to middle-aged men may be orchestrated.

### Schedule Management Using Ai-driven Event Generation

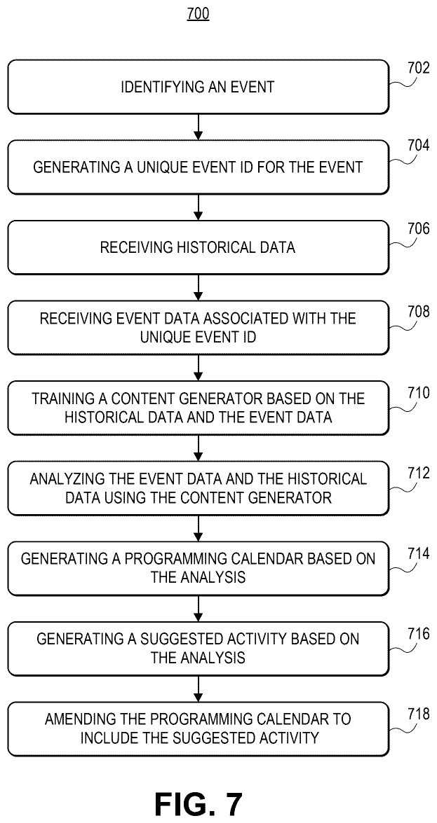

As discussed above, events may be generated using machine learning and added to a schedule. Schedules may be in the form of calendars, such as a calendar depicting all events for a particular time frame. FIG. 7 depicts an exemplary flowchart for illustrating the operation of a method in accordance with embodiments of the invention and generally referred to by reference numeral 700. Method 700 is a method for generating a calendar and suggested activities for the calendar using machine learning. Method 700 may be carried out as a whole or in part by platform 300 depicted in FIG. 3. Step 702, step 704, step 706, step 708, step 710, step 712, and step 716 generally relate to step 602, step 604, step 606, and step 608, step 610, and step 612, and step 614 of FIG. 6, respectively.

In step 710, an activity generator is trained based on the historical data. In some embodiments, the activity generator may be trained to generate a calendar based on inputted data. A calendar may be an organized structure of events and materials based on a time structure. For example, a calendar may be a structure of days of a season. As such, the Method 600 may be carried out as a whole or in part by platform 300 depicted in FIG. 3. generator may be trained to generate a calendar based on a specified time system and activities.

In step 712, the event data is analyzed using the activity generator. In some embodiments, the activity generator analyzes the event data to determine the structure of events in a calendar format. Similarly to step 612 of FIG. 6, the event data may be analyzed to determine correlations between events and outcomes to structure the event data in a calendar format. For example, the event data may be analyzed to determine which events occur first and which events are connected. Thus, in step 714, a programming calendar may be generated based on the analysis performed. The programming calendar may capture which events occurred during particular time frames and which events are to occur in the future at particular times. For example, a programming calendar may capture five seasons of a program and the events occurring during the seasons. An example of a programming calendar is depicted below with regard to FIGS. 8A and 8B

In step 716, a suggested activity is generated based on the analysis performed in step 714. Similarly to step 614 and activity generator 338, an activity may be generated to achieve a particular outcome or metric. For example, a suggested event or material may be generated by the activity generator to achieve a certain metric, such as an engagement goal or a revenue goal. In step 718, the programming calendar generated in step 714 may then be amended to include the suggested activity. For example, if the activity generator generates a new watch party event to take place before the next home game, the programming calendar may be amended to include a watch party occurring one day prior to the next home game.

As discussed above, a programming calendar may capture the temporal relationship between events and materials in relation to a time-keeping system. Further, the programming calendar may be generated using an activity generator, and activities included on the programming calendar may be generated by an activity generator. FIGS. 8A-8B depict an exemplary AI-based programming calendar in accordance with embodiments of the invention and generally referred to by reference numeral 800. Programming calendar 800 is an exemplary calendar depicting a schedule broken down into four periods of time; preseason 804, season 802, postseason 806, and offseason 808. For example, season 802 may be the main season of a program, while preseason 804 may be the events leading up to season 802, and postseason 806 and offseason 808 may be the seasons following season 802. A season may be defined as a period of time in which certain events and activities take place. Seasons may have differing numbers of events and activities. For example, season 802 may have more events than offseason 808.

In some embodiments, programming calendar 800 may include events 810 and empty periods 812, such as events 810a-810g and blank periods 812a-812c. For example, events 810 may include games, while empty periods 812 may include periods in which events or master events do not occur, such as off days and holidays. Certain seasons may have more events 810 or empty periods 812, depending on the programming schedule. Data may be associated with events 810 and empty periods 812, including, for example, information indicative of if the events 810 are home games or away games.

As depicted in FIG. 8B, events 810 and empty periods 812 may have any number of associated activities and events, such as activities 814a-814j. For example, event 810a may be a home game including activities 814a-814e. Activities 814 may be auto populated during generation of programming calendar 800. For example, activities 814a-814e may be based on past season data in which home games had activities 814a-814e. Activities 814 may include any number of activities, including activities 814a-814e, such as sending out a “how was the event” form. Activities 814 may have information on when the activity is to occur. For example, activities 814 may occur before event 810a or after event 810a. In some embodiments, multiple events 810 may have the same activities 814. For example, event 810b and event 810f may include most or all of activities 814a-814e.

In some embodiments, events 810 and/or empty periods 812 may include suggested activities 816, such as suggested activities 816a-816d. Suggested activities 816 are activities generated by an activity generator, such as activity generator 338 depicted in FIG. 3. The suggested activities may be generated and suggested using the techniques described above. As such, suggests activities 816 may be displayed on programming calendar 800. For example, if after event 810d it is determined that the team relating to programming calendar 800 is on a losing streak, suggested activities 816c-816d may be generated to follow event 810d to increase audience morale and engagement. In some embodiments, suggested activities 816 may be automatically populated to programming calendar 800. In other embodiments, suggested activities 816 may be added by a user of programming calendar 800.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A platform for generating an activity associated with an event, the platform comprising:
an event data set corresponding to the event, the event data set comprising a plurality of data types;
an activity generator for generating the event based on the event data set, the activity generator comprising a machine learning model trained on a historical data set,
wherein the activity generator is operable to analyze the event data set to determine one or more activities achieving a predetermined metric, wherein the one or more activities comprise the activity; and
an orchestrator for receiving the activity from the activity generator, wherein the orchestrator provides the activity to a client.

2. The platform of claim 1, further comprising:
a universal event ID generator for generating a first universal event ID associated with the event data set and a second universal event ID, wherein the first universal event ID is different than the second universal event ID.

3. The platform of claim 2, wherein the universal event ID generator comprises:
a universal individual ID generator for generating an individual ID associated with an individual ticket for the event.

4. The platform of claim 3, wherein the universal individual ID generator regenerates the individual ID at a predetermined time.

5. The platform of claim 1, further comprising:
a processing engine for cleansing the event data set such that the event data set is in a standardized format, the processing engine outputting processed data,
wherein the processed data is utilized by the activity generator for generating the activity.

6. The platform of claim 1, wherein the plurality of data types comprise at least one of platform data, communications data, ticket data, purchase data, third-party data, external factor data, or content data.

7. The platform of claim 1, further comprising:
an insights and analytics engine for calculating one or more insights associated with the event data set; and
an automatic event detector, wherein the automatic event detector is a web scraper for locating information indicative of at least one of an additional event or external factor.

8. A method for generating an activity associated with an event, the method comprising:
receiving an event data set associated with the event, wherein the event data set comprises a plurality of data types;
analyzing, via an activity generator, the event data set to determine one or more activities achieving a predetermined metric, wherein the one or more activities comprise the activity;
generating the activity based on the event data set, the activity generator comprising a machine learning model trained on a historical data set; and
outputting the activity to an orchestrator such that the orchestrator can provide the activity to a client.

9. The method of claim 8, wherein receiving the event data set associated with the event comprises:
scraping, using an automatic event detector, one or more web pages to gather the event data set associated with the event.

10. The method of claim 8, wherein the machine learning model is a generative machine learning model.

11. The method of claim 8, wherein the method further comprises:
generating a universal event ID associated with the event data set and the event, wherein the activity generator distinguishes an input based on the universal event ID.

12. The method of claim 8, further comprising:
receiving the historical data set comprising at least one of a past event, a past content, or a past material; and
training the machine learning model to generate the one or more activities using the historical data set.

13. The method of claim 8, wherein the predetermined metric is a predetermined threshold, where the event exceeds the predetermined threshold.

14. The method of claim 8, the method further comprising:
generating, via the activity generator, a programming calendar comprising:
a plurality of existing events including the event; and
the activity, wherein the activity includes information indicative of a time of occurrence relative to the event.

15. One or more non-transitory computer-readable media comprising computer-executable instructions that, when executed by at least one processor, perform a method of generating an activity associated with an event, the method comprising:
receiving an event data set associated with the event, wherein the event data set comprises a plurality of data types;
analyzing, via an activity generator, the event data set to determine one or more activities achieving a predetermined metric, wherein the one or more activities comprise the activity;
generating the activity based on the event data set, the activity generator comprising a machine learning model trained on a historical data set; and
outputting the activity to an orchestrator such that the orchestrator can automatically update a programming calendar to include the activity.

16. The one or more non-transitory computer-readable media of claim 15, wherein the event data set includes a plurality of data formats such that at least one of a first syntax or a first semantic of a first data subset in the event data set differs from at least one of a second syntax or a second semantic of a second data subset in the event data set.

17. The one or more non-transitory computer-readable media of claim 16, wherein the method further comprises:
processing the event data set such that the event data set is in a standardized format and a first format of the first data subset is identical to a second format of the second data subset.

18. The one or more non-transitory computer-readable media of claim 15, wherein the method further comprises:
generating a second event based on a second event data set, where the event is a first event and the event data set is a first event data set.

19. The one or more non-transitory computer-readable media of claim 18, wherein the method further comprises:
updating the programming calendar to include the second event; and
causing display of, via a graphical user interface, the programming calendar to a client.

20. The one or more non-transitory computer-readable media of claim 15, wherein the method further comprises:
determining, using the machine learning model, one or more insights relating to the event data set; and
formatting the one or more insights into at least one of a graph or a chart.
